(19) United States
(12) Patent Application Publication
(10) Pub. No.: US 2025/0212133 A1
(43) Pub. Date: Jun. 26, 2025

(54) ACTIVE RADIATION PATTERN MANAGEMENT AS A FUNCTION OF ORIENTATION

(71) Applicant: SAGEMCOM BROADBAND SAS, Bois-Colombes (FR)

(72) Inventor: Serge CONTAL, Bois-Colombes (FR)

(21) Appl. No.: 18/988,082

(22) Filed: Dec. 19, 2024

(30) Foreign Application Priority Data
Dec. 20, 2023 (FR) FR2314646

(51) Int. Cl. H04W 52/28; H04W 52/24; H04W 52/42

(52) U.S. Cl. CPC H04W 52/283; H04W 52/24; H04W 52/42

(57) ABSTRACT

A piece of equipment includes a radiofrequency device designed to generate a radiated power which, when the equipment is installed with a nominal orientation, is less than a first threshold in the direction of a first zone and is less than a second threshold in the direction of a second zone, the second threshold being less than the first threshold; and a processor module designed, if the current orientation differs from the nominal orientation and is such that the power radiated in the direction of the second zone is likely to exceed the second threshold, to operate the device in order to limit the power radiated in the direction of the second zone and thus ensure that the power radiated in the direction of the second zone again becomes less than the second threshold.

The invention relates to the field of equipment comprising a radiofrequency device, such as access points for example.

### BACKGROUND

Certain standards or regulations require equipment which incorporates a radiofrequency device for transmitting radiofrequency signals to transmit a radiated power that is less than a first predefined power threshold in the direction of a first reference zone, and that is less than a second predefined power threshold in the direction of a second reference zone, the second predefined power threshold being less than the first predefined power threshold.

The second reference zone is, for example, a vertical cone whose apex is the equipment, and the first reference zone is, for example, all of the space around the equipment, with the exception of said cone.

Thus, for example, the American Wi-Fi AFC (Automatic Frequency Control) regulation requires an access point that is located in certain strategic geographical locations to strongly limit the transmitted power above a certain elevation angle so as not to harm telecommunication links based on protocols sharing certain specific frequency bands (FCC 47 CFR 15.407 (n)). Likewise, Canadian Industry Canada regulations also through RSS-247, certain impose, limitations depending on the elevation.

FIG. 1 shows an example corresponding to a 30 degree elevation limitation imposed on certain equipment 0 in the United States in the 6 GHz band. The Equivalent Isotropic Radiated Power (“EIRP”) is limited to 21 dBm above a 30-degree elevation angle from the horizon, while being limited to 36 dBm below 30 degrees (so the radiated power can be 15 dB higher below the 30-degree elevation angle).

Manufacturers are therefore designing radiofrequency devices that generate limited radiated power above a certain elevation angle. This limitation can be obtained in various ways and, for example:
by limiting the power transmitted by the amplifier of the radiofrequency device. This limitation is however obtained to the detriment of the overall coverage;
by physically distorting the radiation pattern in one direction;
by using horizontal directional antennas.

However, these different methods are only effective when the equipment 0 is in its nominal position. A poor positioning of the equipment 0 leads to poor orientation of the “distortion” and therefore regulatory non-compliance and poor coverage.

Indeed, if the equipment 0 in FIG. 1 is not placed flat, its transmission zone within 30 degrees having an EIRP limit of 36 dBm may spill over into the zone limited to an EIRP of 21 dBm. The equipment 0 is then no longer in compliance with the regulations and its coverage is degraded.

### Object

An object of the invention is to ensure that a piece of equipment comprising a radiofrequency device remains compatible, whatever its orientation, with power limitation requirements that differ according to the direction.

### SUMMARY

In order to achieve this object, a piece of equipment is proposed comprising:
a radiofrequency device designed to transmit radiofrequency signals by generating a radiated power which, when the equipment is installed with a nominal orientation, is less than a first predefined power threshold in the direction of a first reference zone and is less than a second predefined power threshold in the direction of a second reference zone, the second predefined power threshold being less than the first predefined power threshold;
a measuring device designed to measure at least one quantity representative of a current orientation of the equipment;
a processor module designed, if the current orientation of the equipment differs from the nominal orientation and is such that the power radiated in the direction of the second reference zone is likely to exceed the second predefined power threshold, to operate the radiofrequency device in order to limit the power radiated in the direction of the second reference zone and thus ensure that the power radiated in the direction of the second reference zone again becomes less than the second predefined power threshold.

The processor module therefore acquires the measurements of the quantity or quantities representative of the current orientation of the equipment. If the current orientation is such that the power radiated in the direction of the second reference zone (a vertical cone for example) risks exceeding the second predefined power threshold because of the inclination of the equipment, the processor module limits the power radiated in the direction of this second reference zone. This ensures that the equipment remains compliant with the regulations relating to transmission powers, which differ according to the direction, regardless of the current orientation of the equipment.

In addition, a piece of equipment such as described above is proposed, in which, in order to limit the power radiated in the direction of the second reference zone, the processor module is designed to limit an electrical power of at least one electrical signal applied between terminals of at least one antenna of the radiofrequency device.

Also proposed is a piece of equipment as described above, the radiofrequency device comprising a beam steering system comprising an array of a plurality of antennas, the processor module being designed, to limit the radiated power, to control phases of electrical signals applied between terminals of the antennas of the beam steering system so as to modify a direction of transmission of an electromagnetic beam generated by the beam steering system.

In addition, a piece of equipment such as described above is proposed, the processor module being designed to select, from a predefined table, for all the antennas, phase values associated with the current orientation of the equipment and such that the power radiated in the direction of the second reference zone is less than the second predefined power threshold, and to operate the beam orientation system so that it allocates said phase values to the electrical signals applied to the terminals of the antennas.

In addition, a piece of equipment such as described above is proposed, wherein, if the predefined table does not comprise phase values associated with the current orientation and such that the power radiated in the direction of the second reference zone is less than the second predefined power threshold, the processor module selects the phase values associated with the current orientation and with the lowest radiated power value in the direction of the second reference zone, and also limits an electrical power of at least one electrical signal applied between the terminals of at least one antenna.

In addition, a piece of equipment such as described above is proposed, wherein the current orientation is defined by an azimuth angle and an elevation angle, the predefined table having been obtained from measurements of radiation patterns according to the azimuth angle and the elevation angle, carried out for the different phase values.

In addition, a piece of equipment such as described above is proposed, the radiofrequency device comprising antennas, a radiofrequency transmission chain designed to produce electrical signals, and at least one switch designed to implement configurable connections between the antennas and the radiofrequency transmission chain, the processor module being designed, in order to limit the radiated power, to operate the at least one switch so as to reconfigure the configurable connections.

In addition, a piece of equipment such as described above is proposed, wherein the at least one quantity representative of current the orientation of the equipment comprises at least one acceleration of the equipment along a predefined axis.

In addition, a piece of equipment such as described above is proposed, the processor module being designed to convert the at least one acceleration into at least one angle with respect to at least one reference direction or reference plane.

In addition, a piece of equipment such as described above is proposed, wherein the processor module is also designed to produce a notification to a user of the equipment, requesting the user to reposition the equipment in order to reinstall it with the nominal orientation.

In addition, a piece of equipment such as described above is proposed, wherein the second reference zone is a vertical angular cone having the equipment as its apex.

In addition, a piece of equipment such as described above is proposed, the equipment being an access point.

Also proposed is a method for transmitting radio frequency signals, implemented in the processor module of a piece of equipment such as described above, and comprising the steps of:
acquiring measurements of the at least one quantity representative of the current orientation of the equipment;
if the current orientation of the equipment is such that the power radiated in the direction of the second reference zone is likely to exceed the second predefined power threshold, operating the radiofrequency device to limit the power radiated in the direction of the second reference zone and thus to ensure that the power radiated in the direction of the second reference zone again becomes less than the second predefined power threshold.

In addition, a computer program is proposed, comprising instructions which lead the processor module of the equipment such as described above to execute the steps of the radiofrequency signal transmitting method such as described above.

In addition, a computer-readable storage medium is proposed, on which the computer program such as described above is stored.

The invention will be best understood, in the light of the description below of particular, non-limiting embodiments of the invention.

### BRIEF DESCRIPTION OF THE DRAWINGS

Reference will be made to the accompanying drawings, among which:

FIG. 1 shows the EIRP limits as a function of elevation for a piece of equipment from the prior art;

FIG. 2 shows a piece of equipment according to a first embodiment;

FIG. 3 shows a three-axis accelerometer;

FIG. 4 shows steps of a transmission method;

FIG. 5 shows a piece of equipment according to a second embodiment, as well as electromagnetic beams;

FIG. 6 also shows the equipment according to the second embodiment;

FIG. 7 is a view similar to that of FIG. 5, when the equipment is inclined;

FIG. 8 shows the vertical cone, a reference frame defined by a nominal position of the equipment and a reference frame defined by an inclined position of the equipment;

FIG. 9 shows the vertical cone in a radiation pattern while the equipment is in its nominal position;

FIG. 10 shows the vertical cone in a radiation pattern while the equipment is in an inclined position;

FIG. 11 shows a piece of equipment according to a third embodiment;

FIG. 12 shows radiation patterns for the equipment positioned in various orientations;

FIG. 13 shows a piece of equipment according to a fourth embodiment.

### DETAILED DESCRIPTION

With reference to FIG. 2, here the equipment according to a first embodiment is a Wi-Fi access point 1 that incorporates a radiofrequency device 2, a measuring device 3 and a processor module 4.

The radiofrequency device 2 comprises one or more antennas 5 (in this case a plurality of antennas) and a radiofrequency transmission chain 6 connected to the antennas 5 and comprising one or more amplifiers 7 (in this case a plurality of amplifiers). The amplifiers 7 produce electrical signals which are applied between the terminals of the antennas 5 so that the antennas transmit radiofrequency signals for the access point 1 to implement a Wi-Fi network. The antennas 5 also receive radiofrequency signals.

The radiofrequency device 2 is designed to transmit radiofrequency signals of a certain frequency band (in this case the UNII5 band) by generating a radiated power which, when the access point 1 is installed with a nominal orientation, is less than a first predefined power threshold in the direction of a first reference zone and is less than a second predefined power threshold in the direction of a second reference zone, the second predefined power threshold being less than the first predefined power threshold. The first reference zone and the second reference zone are defined with respect to one or more reference axes or planes (for example vertical axis, horizontal plane, vertical plane, etc.) and are therefore defined independently of the current orientation of the access point 1.

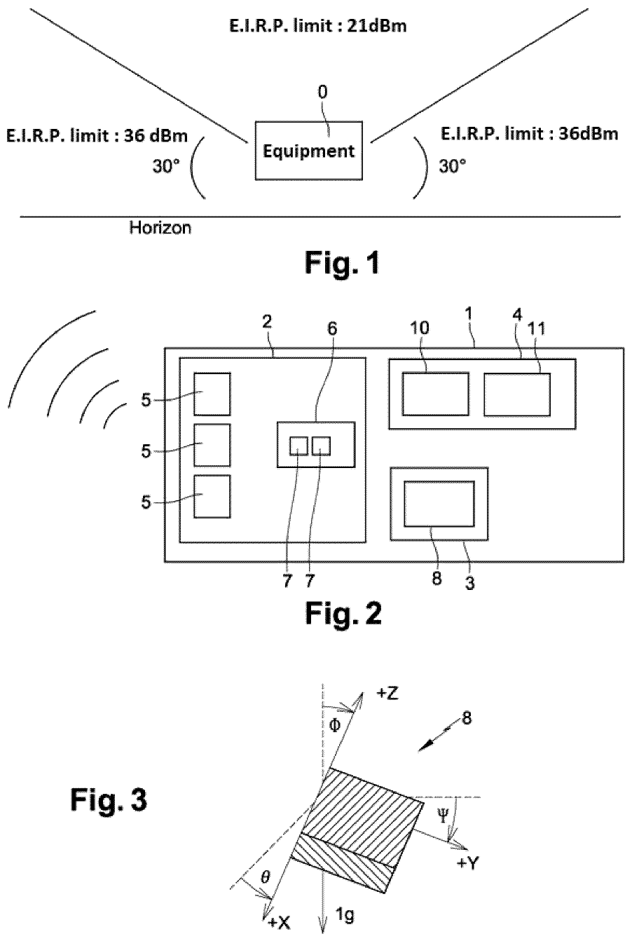

In this case, the second predefined zone is a vertical angular cone having the access point 1 as its apex and defined by a minimum elevation angle. In this case, this minimum elevation angle is equal to 30° (relative to a horizontal plane), as shown in FIG. 1.

The first reference zone corresponds to all of the space around the access point 1 with the exception of said cone.

The nominal orientation of the access point 1 is the orientation defined in the user manual. When the access point 1 is installed with its nominal orientation, it is placed “upright”, for example vertically, on a support that is itself substantially parallel to a horizontal plane.

The access point 1 therefore generates a radiated power that differs according to the direction.

The access point 1 thus complies with the American Wi-Fi AFC regulation which requires, as has been seen, that if the active channel is in the UNII5 band, then the power transmitted above this elevation of 30° is limited with an EIRP limit of 21 dBm, whereas the EIRP limit is 36 dBm in the other directions.

The measurement device 3 produces measurements of at least one quantity representative of the current orientation of the access point 1. For example, the at least one quantity comprises at least one acceleration of the access point 1 along a predefined axis.

In this case, the measuring device 3 comprises a three-axis accelerometer 8, which is, for example, a MEMS (Micro Electro-Mechanical System) component.

This is, for example, the LIS2HH12 component from STMicroelectronics. Its small size (4 mm²) and the fact that it can communicate with a processor or a microcontroller using the I²C or SPI protocols, make this component very easy to incorporate into a piece of equipment such as the access point 1.

With reference to FIG. 3, the accelerometer 8 typically gives the following values, when the access point 1 is installed with a nominal orientation:
X-axis accelerometer (m/s²): 0
Y-axis accelerometer (m/s²): 0
Z-axis accelerometer (m/s²): −9.81

The processor module 4 is an electronic and software unit. The processor module 4 comprises at least one processing component 10, which is for example, a “general purpose” processor, a processor specialising in signal processing (or DSP, for Digital Signal Processor), a processor specialising in artificial intelligence algorithms (NPU-type, for Neural Processing Unit), a microcontroller, or a programmable logic circuit such as an FPGA (for Field Programmable Gate Arrays) or an ASIC (for Application Specific Integrated Circuit).

The processor module 4 also comprises one or more memories 11, connected to or integrated in the processing component 10. At least one of these memories 11 forms a computer-readable storage medium, on which at least one computer program is stored, comprising instructions that cause the processor module 4 to execute at least some of the steps of the radiofrequency signal transmission method that will be described.

The manner will now be described in which the radiofrequency device 2, the measurement device 3 and the processor module 4 cooperate so that the transmissions produced by the access point 1 remain compliant with American Wi-Fi AFC regulations, even when the access point 1 is incorrectly installed: placed upside down, inclined, placed upright but on an inclined support, etc.

Since the power radiated in the direction of the first reference zone may be greater than the second power threshold when the access point 1 is correctly installed, there is a risk, if the access point 1 is incorrectly installed, that the power radiated in the direction of the second reference zone may become greater than the second predefined power threshold.

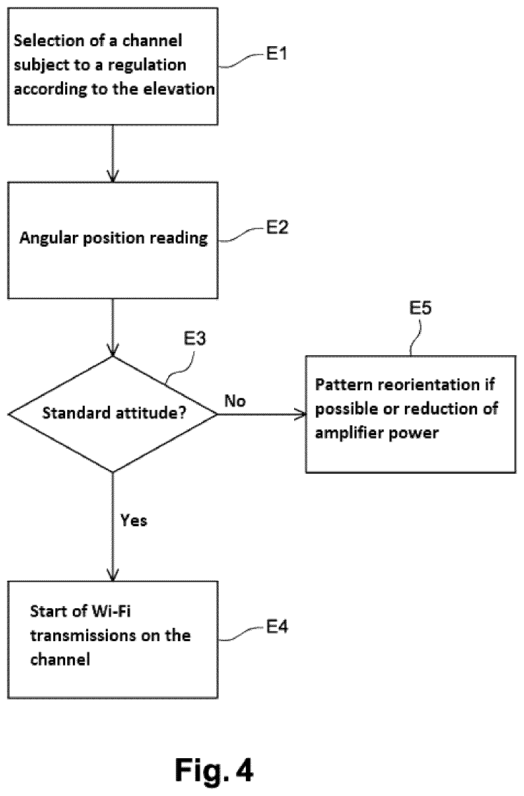

The various steps of the transmission method, visible in FIG. 4, are implemented in the processor module 4.

The access point 1 selects a channel subject to a regulation according to the elevation: step E1. The access point 1 is therefore about to transmit radiofrequency signals in the UNII5 band.

The measurement device 3 produces the measurements of the accelerations along the three axes. The processor module 4 acquires these measurements (but in this case only uses the acceleration along the axis Z): step E2.

The processor module 4 compares the acceleration along the axis Z with a predefined acceleration threshold, which is, for example, equal to −8 m/s², which corresponds to an inclination of approximately 10° with respect to the horizon: step E3.

As long as the acceleration along the axis Z remains less than this predefined acceleration threshold (in this case less than or equal to), the processor module 4 considers that the attitude of the access point 1 corresponds to its nominal attitude and therefore that it is installed with a nominal orientation. The accelerometer data may be, for example, (0, 0, −9.81) m/s².

The radiated power is therefore compliant with the regulations. The radiation pattern is therefore “ideal”, and the access point 1 therefore transmits at most 36 dBm EIRP below 30° above the horizon and at most 21 dBm EIRP above 30° above the horizon. The processor module 4 therefore does not modify the setting of the radiofrequency device 2 which therefore transmits the radiofrequency signals in the UNII5 band in a nominal manner: step E4.

The method returns to step E1.

It may happen that the current orientation of the access point 1 is modified, for example because of an impact, which also modifies the acceleration along the axis Z. The current orientation of the access point 1 then differs from the nominal orientation and is therefore such that the power radiated in the direction of the second reference zone is likely to exceed the second predefined power threshold.

In this case, the accelerometer data switches, for example, to (−1, −6, −5) m/s². In step E3, the acceleration along the axis Z therefore becomes equal to −5 m/s² and therefore greater than the predefined acceleration threshold.

As a result, the radiated power in the aforementioned vertical cone may become greater than the second predefined power threshold. The access point 1 therefore no longer functions in accordance with the regulations.

The processor module 4 operates the radiofrequency device 2 to limit the power radiated in the direction of the second reference zone and thus to ensure that the power radiated in the direction of the second reference zone again becomes less than the second predefined power threshold.

For this purpose, the processor module 4 limits the electrical power of at least one electrical signal applied by at least one of the amplifiers 7 of the radiofrequency device 2 between the terminals of at least one of the antennas 5 of the radiofrequency device 2: step E5. The limitation is made at any point of the radiofrequency transmission chain 6 connected to the antenna (upstream or downstream or at the one or more amplifiers 7, at the antenna connector, etc.).

At the same time, the processor module 4 generates and transmits a notification to the user of the access point 1, for example by transmitting a message to the user's smartphone. This notification asks the user to reposition the access point 1, in order to reinstall it with the nominal orientation.

The method then moves to step E4.

The power limitation is maintained as long as the acceleration along the axis Z remains greater than the predefined acceleration threshold (here strictly greater than). Normally, following receipt of the notification, the user will quickly reposition the access point 1 and the acceleration along the axis Z returns to approximately −9.81 m/s² and thus becomes less than the predefined acceleration threshold. The access point 1 therefore retransmits at “high” power.

It can be seen that only the acceleration along the axis Z is taken into account, so that a single-axis accelerometer could be used.

It should be noted that in step E3, the comparison can be made with several predefined acceleration thresholds. It is the acceleration modulus that can be compared with one or more thresholds, rather than the acceleration value itself. The compared acceleration may be an average of several acceleration measurements, measured over a predefined period of time.

In an alternative embodiment, the processor module 4 compares not one acceleration along a single axis, but a plurality of accelerations along a plurality of axes, which is easy to achieve because the accelerometer 8 is a three-axis accelerometer.

In another alternative embodiment, the processor module 4 acquires the acceleration measurements and converts them into at least one angular value with respect to at least one reference direction or at least one reference plane.

The processor module 4 can, for example, obtain the angular values θ, ψ, φ (visible in FIG. 3) by using the following formulas:

$$θ = {tan}^{- 1} ( \frac{{A}_{X}}{\sqrt{{A}_{Y}^{2} + {A}_{Z}^{2}}} )$$

$$ψ = {tan}^{- 1} ( \frac{{A}_{Y}}{\sqrt{{A}_{X}^{2} + {A}_{Z}^{2}}} )$$

$$Φ = {tan}^{- 1} ( \frac{\sqrt{{A}_{X}^{2} + {A}_{Y}^{2}}}{{A}_{Z}} ) ,$$

where A_{X} is the acceleration measured along the axis X by the accelerometer 8, A_{Y} is the acceleration measured along the axis Y, and A_{Z} is the acceleration measured along the axis Z.

The processor module 4 can be satisfied with the angular value φ (inclination with respect to the vertical).

In step E3 of the method of FIG. 3, the processor module 4 therefore compares the current orientation with at least one predefined angular threshold. In this case, the current orientation is therefore estimated by evaluating the angular value φ. The predefined angular threshold is, for example, equal to ±5°.

As long as the attitude is nominal, that is as long as

$$- 5 ° \leq Φ \leq + 5 ° ,$$

the processor module 4 does not modify the configuration of the radiofrequency device 2, which therefore transmits the radiofrequency signals in the UNII5 band in a nominal manner.

If the attitude is not nominal, in other words if:

$$Φ > 5 ° or Φ < - 5 ° ,$$

then the processor module 4 limits the radiated power in order to ensure that the power radiated in the direction of the second reference zone again becomes less than the second predefined power threshold.

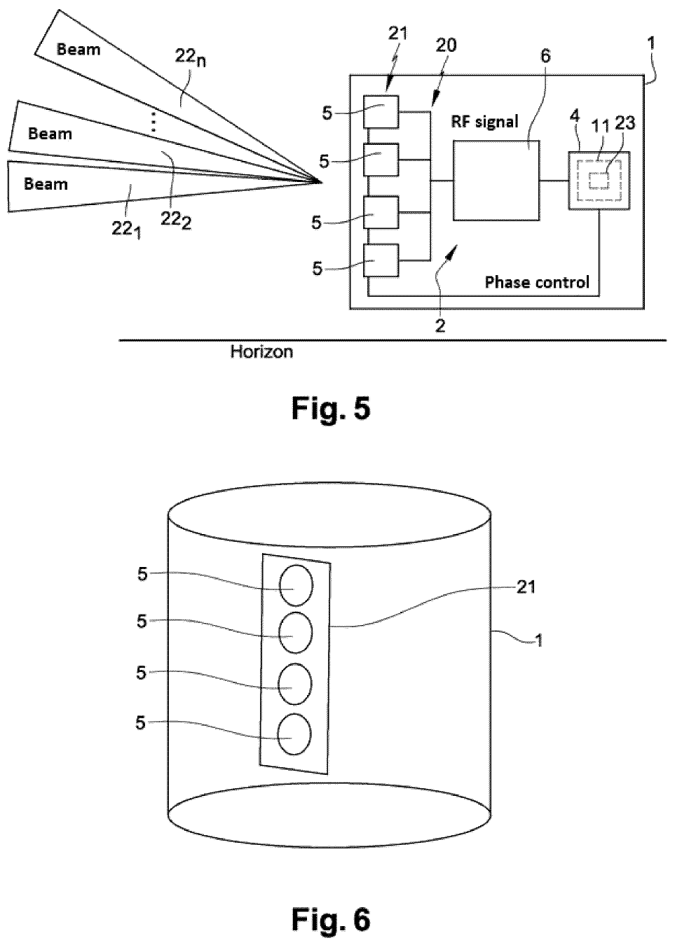

An access point 1 according to a second embodiment is now considered with reference to FIGS. 5 to 7.

The radiofrequency device 2 includes a beam steering system 20.

The beam steering system 20 includes an array 21 of a plurality of antennas 5 and the radiofrequency transmission chain 6.

This antenna array 21 forms an overall antenna consisting of several sub-antennas (the antennas 5) whose phase is controllable, thereby making it possible to control the orientation of the electromagnetic (beam) 22 transmitted by the system. Reference is made to beam steering to designate this technique, which is a specific case of beamforming.

As can be seen in FIG. 6, the antenna array 21 in this case includes four antennas 5 that extend vertically. The beam 22 is therefore vertically controllable.

The processor unit 4 can operate the transmission chain 6 and control the phase of each electrical signal applied between the terminals of each antenna 5, so as to control the direction of transmission of the electromagnetic beam 22 generated by the beam steering system. Various differently oriented beams 22₁, 22₂, . . . , 22ₙ can therefore be generated by the radiofrequency device 2.

When the current orientation of the access point 1 differs from the nominal orientation, the processor module 4 will, in order to limit the power radiated in the direction of the vertical cone, control phases of the electrical signals applied between the terminals of the antennas 5 of the beam steering system 20, so as to modify the direction of transmission of the electromagnetic beam generated by the beam steering system 20.

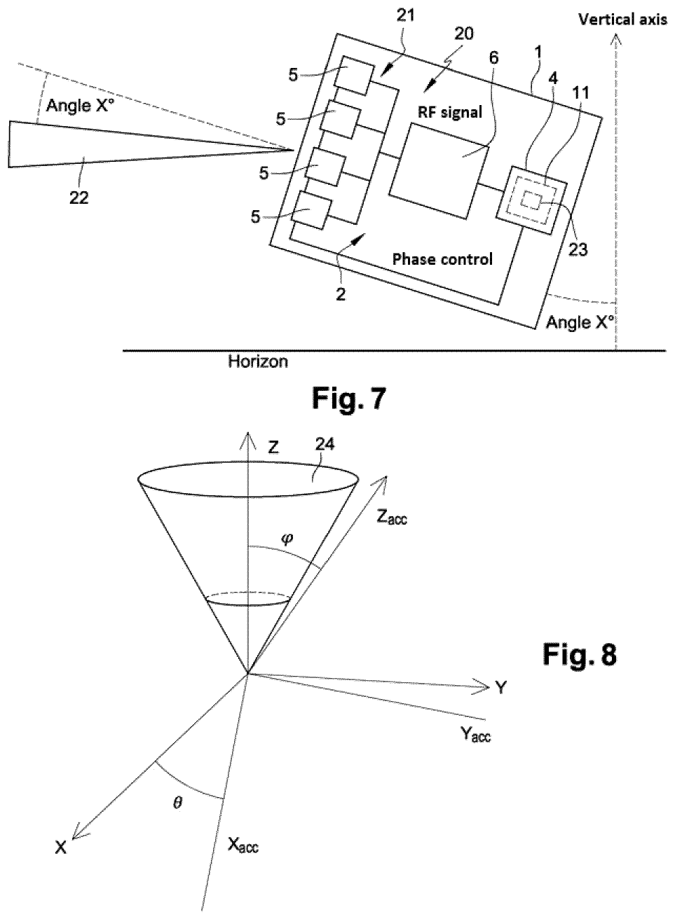

As can be seen in FIG. 7, when the access point 1 is inclined at an angle of X° relative to a vertical axis, the processor module 4 typically imparts an equivalent angle to the beam 22 to ensure that the radiated power remains compliant with the directional requirements.

To change the direction of transmission of the beam, the processor module 4 uses a predefined table 23.

The predefined table 23 is completed by the manufacturer of the access point 1 during a calibration phase carried out for example following the assembly of the access point 1 and prior to its delivery. The predefined table 23 is, for example, stored in one of the memories 11 of the processor module 4. The values it contains can optionally be updated and/or configured, possibly remotely or by the user.

The processor module 4 selects, from the predefined table 23, for all the antennas 5, phase values associated with the current orientation of the access point 1 and such that the power radiated in the direction of the second reference zone is less than the second predefined power threshold, then operates the beam orientation system 20 so that it allocates said phase values to the electrical signals applied to the terminals of the antennas 5.

In this case, with reference to FIG. 8, the current orientation is defined by an azimuth angle θ and an elevation angle φ (in spherical coordinates). These angles are either measured by the measuring device 3, or are evaluated by the processor module 4 from other quantities measured by the measuring device 3 (accelerations, for example).

It should be noted that this time, the vertical cone 24 is defined by an angle φ less than 60°.

The predefined table 23 has been obtained from measurements of radiation patterns according to the azimuth angle and the elevation angle, carried out for different phase values.

During the calibration phase, the manufacturer of the access point 1 has measured all possible combinations of radiation patterns as a function of the phase values allocated to the electrical signals applied to the terminals of each of the four antennas 5 of the antenna array 21.

It is possible, for example, to limit the controlling of the phase of the antennas 5 to 90° steps, in order to have 360/90=4 possible values per antenna 5. The phase values are therefore 0°, 90°, 180°, 270°.

Each radiation pattern was therefore measured as a function of the azimuth and elevation angles, with angular steps of 5° for example. The manufacturer has obtained radiated power values from the radiation patterns, which are associated with the different combinations of phase values.

The predefined table 23 comprises:
first combinations between all the angular steps of the azimuth angle and the elevation angle;
second combinations between all the phase values for all the antennas;
each first combination is associated with all the second combinations, in order to form third combinations;
each third combination is associated with a value of radiated in the direction of the second reference zone.

Thus:
there are four phase values for each antenna, i.e. 4×4×4×4=256 combinations of phase values;
if the radiation pattern is measured in angular steps of 5° in azimuth and elevation, we have (180/5+1)*(360/5+1)=2701 angle values in total.

256*2701≈700,000 third combinations of values of phase/angular step/antenna are thus obtained.

This large number should be put into perspective. It typically takes 10 ms to make a measurement of one phase per position, or about 3 seconds to measure the 256 phases per position.

The predefined table 23 can also indicate, for each third combination, the phase values that make it possible to obtain the minimum (and/or maximum) EIRP for each cone of 2*60 degrees describing the sphere (the angle φ of 60 degrees corresponds here to the cone defined by the FCC at 6 GHz but the same principle can be applied for any angular restriction).

The table 23 is, for example, similar to the table in the Appendix.

In the case where the access point 1 is subject to an inclination, it is therefore necessary to calculate the zone of the radiation pattern which is subjected to the EIRP restriction.

The processor module 4 therefore acquires the acceleration measurements, converts them into azimuth angles θ and elevation angles φ, then goes through the table 23 to find the zone corresponding to the 60° cone.

The processor module 4 finds the zone of the 60° cone by shifting the centre of the cone by θ in azimuth and by φ in elevation.

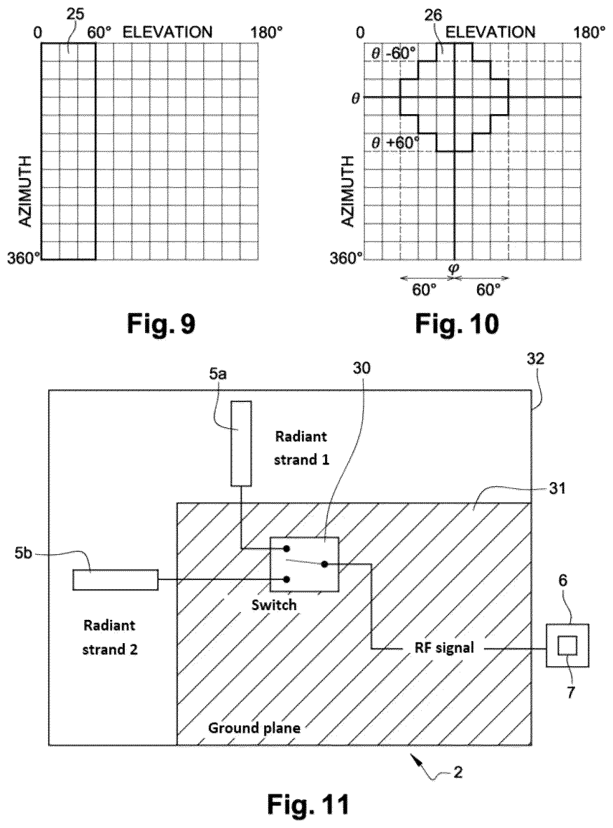

With reference to FIG. 9, when the access point 1 is in its nominal position (φ=0°), the vertical cone corresponds in the radiation pattern to the North pole and therefore to the entire zone 25 located below 60° of elevation.

With reference to FIG. 10, when the access point 1 is inclined by (θ, φ), the vertical cone can be traversed discretely starting from θ and φ and adding 60° on each side. The vertical cone is seen on the radiation diagram as a discretely represented circle: zone 26. The highest value of the EIRP inside this zone is recorded, as well as the lowest.

The predefined table 23 therefore contains all the cones of axis described by the angles of inclination θ and φ.

In the exemplary table in the appendix, it can therefore be seen that if the access point 1 is subject to an inclination of (θ, φ)=(145°, 70°), then the processor module 4 selects the phase values (90°, 270°, 90°, 90°), which makes it possible to obtain a radiated power with an EIRP of 15 dBm in the vertical cone.

The processor module 4 therefore calculates the angles of inclination θ and φ, defining the current orientation of the access point 1.

If the current orientation of the access point 1 requires a limitation, the processor module 4 checks in the predefined table 23 that there is indeed a combination of phase values for which the power radiated in the direction of the second reference zone is less than the second predefined power threshold (in other words, in this case, for which the EIRP in the cone is less than the limitation of 21 dBm).

If this is the case, the processor module 4 selects these phase values and operates the beam steering system 20 so that the latter allocates said phase values to the electrical signals applied to the terminals of the antennas 5.

If the predefined table 23 does not comprise phase values associated with the current orientation and such that the power radiated in the direction of the second reference zone is less than the second predefined power threshold, then the processor module 4 selects the phase values associated with the current orientation and with the lowest radiated power value in the direction of the second reference zone, and further limits the electrical power of at least one electrical signal applied between the terminals of at least one antenna 5.

The processor module 4 therefore selects the combination that gives the smallest EIRP and, in addition, lowers the transmitted power to return to the value of 21 dBm. For example, if in the zone of the cone there is a maximum EIRP at 24 dBm, then the processor module 4 can lower the power of the electrical signal by 3 dB (at the antenna connector, for example).

In both cases, the beam steering system 20 produces a beam that allows the access point to remain compliant with the regulations.

Of course, this example is not exhaustive. It is possible to increase or decrease the number of phase values, angular steps, the number of operable elements (antennas), etc.

Alternatively, the processor module 4 uses a mathematical formula describing the vertical cone exactly. This solution is advantageous if the number of values is increased (reduced angular steps, more phase values, etc.).

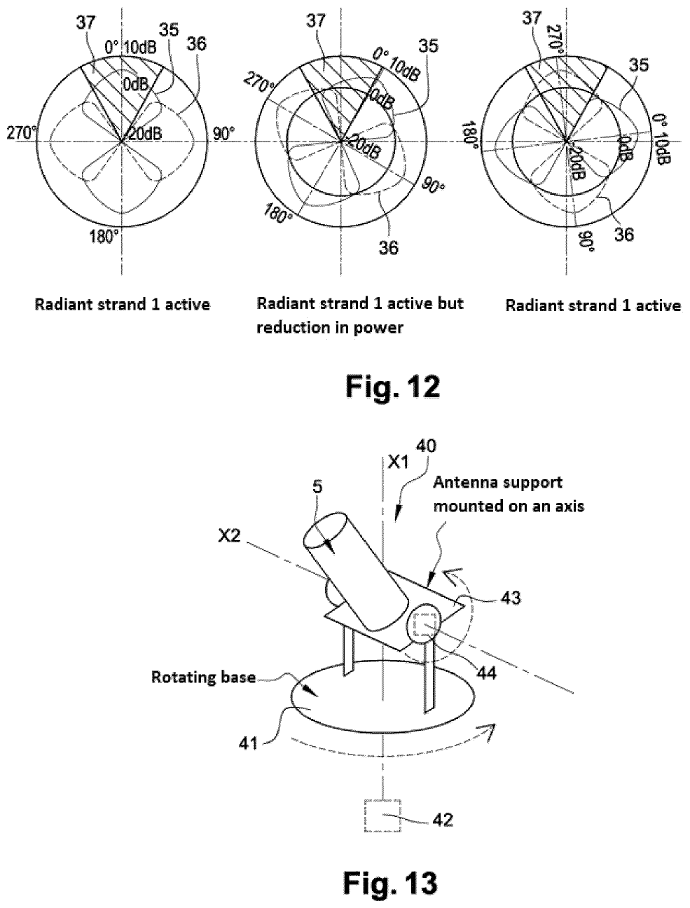

A third embodiment will now be considered with reference to FIGS. 11 and 12.

In this embodiment, the radio frequency device 2 comprises antennas 5a, 5b, a transmission chain 6 comprising one or more amplifiers 7, and at least one switch 30 designed to implement configurable connections between the antennas 5 and the transmission chain 6.

Reference is made to a smart antenna to designate this system, or a reconfigurable antenna, or even beam switching.

In the example of FIG. 11, the radiofrequency device 2 comprises two antennas 5a, 5b (for example two radiating strands). The switch 30 is a switch with one input and two outputs. Each output of the switch 30 is connected to a separate radiating strand 5a, 5b.

An electrical signal produced by the chain 6 is applied to the input of the switch 30 and is transmitted selectively to one or both radiating strands 5a, 5b (or to neither).

The imprint accommodating the switch 30 is positioned inside a ground plane 31 on a printed circuit 32 of an electrical circuit board of the access point, and the electrical signal at the input and output of the switch 30 travels on tracks defined inside this ground plane 31.

With reference to FIG. 12, in this example with two radiating elements, the two radiating strands are oriented at 90° relative to each other and therefore have a complementary antenna pattern: pattern 35 for the radiating strand 5a and pattern 36 for the radiating strand 5b. When the access point 1 is pivoted parallel to the plane of the pattern shown, the radiation patterns 35, 36 are also pivoted by the same angle.

In the left-hand diagram of FIG. 12, the access point is not pivoted. It is the radiating strand 5a that is active in the direction of the vertical cone.

In the central diagram of FIG. 12, the access point 1 has pivoted through an angle of approximately 30°. Radiating strand 5a is active but with a reduction in power.

In the right-hand diagram of FIG. 12, the access point has pivoted through an angle of approximately 85°. Radiating strand 5b is active.

Three zones can therefore be delimited in the radiation diagram according to the inclination of the access point 1:
Zone 1: Radiant strand 5a active;
Zone 2: Radiant strand 5b active;
Zone 3: power reduction zone, with one or the other active (by default the highest).

In FIG. 12, the second reference zone is the zone 37. In the central diagram, it is seen that the resulting gain is always high in the limited zone. It is therefore appropriate to reduce the radiated power in order to reach the limit.

To limit the power radiated in the direction of the second reference zone, the processor module 4 operates the switch 30 so as to reconfigure the reconfigurable connections (in this case, the connections between the radiating strands 5a, 5b and the chain 6).

When the current orientation of the access point 1 differs from the nominal orientation and is such that the power radiated in the direction of the second reference zone can exceed the second predefined power threshold, the processor module 4 can operate the switch 30 so that the radiated power is at the minimum level so that, whatever the gain of the antennas, the limitation on the high elevation is always respected.

Alternatively, if the processor module 4 knows the inclination and the gain according to the inclination of the antennas 5a, 5b, the processor module 4 can configure the configurable connections so as to reduce the power while being close to the limit.

For example, if the antenna gain is 5 dBi maximum in the restricted zone, and this restricted zone is at 23 dBm EIRP, the processor module 4 lowers the power, for example at the antenna connector, to 23−5=18 dBm.

There are only two radiating elements in FIGS. 11 and 12, but the above obviously applies to a system comprising a greater number of switchable elements and therefore more different patterns and therefore fewer zones where the power must be reduced.

In a fourth embodiment, with reference to FIG. 13, the radiofrequency device 2 incorporates an antenna 5 mounted on a rotating mechanical support 40. The support comprises a rotating base 41 rotated by a first motor 42 and an antenna support 43 rotated by a second motor 44.

The two motors 42, 44 are, for example, two servomotors or stepper motors, which therefore control two axes X1, X2.

The processor module pivots the antenna 5 so that it remains in its initial vertical position.

To limit the power radiated in the direction of the second reference zone, the processor module controls the two motors 42, 44 in order to control the angle of the antenna and thus correct the radiation to compensate for the inclination of the equipment. This control is carried out by the processor module using, for example, the PWM (Pulse Width Modulation) technique.

Naturally, the invention is not limited to the embodiments described, but comprises any variant entering into the field of the invention.

The equipment in which the invention is implemented need not necessarily be an access point, it could be any equipment transmitting radiofrequency signals.

The second reference zone is not necessarily a vertical cone, it could for example be a zone defined between a positive elevation angle and a negative elevation angle defined with respect to a horizontal plane.

The predefined table could be different to that described here. For example, it could contain acceleration steps rather than angular steps.

### APPENDIX

Example of a predefined table:

| | | EIRP | Max | Phase 1 | Phase 2 | Phase 3 | Phase 4 |
|---|---|---|---|---|---|---|---|
| θ° | φ° | (in dBm) | or Min | (in °) | (in °) | (in °) | (in °) |
| . . . | . . . | . . . | . . . | . . . | . . . | . . . | . . . |
| 145 | 70 | 24 | Max | 0 | 90 | 0 | 270 |
| 145 | 70 | 15 | Min | 90 | 270 | 90 | 90 |
| . . . | . . . | . . . | . . . | . . . | . . . | . . . | . . . |

1. A piece of equipment, comprising:
a radiofrequency device designed to transmit radiofrequency signals by generating a radiated power which, when the equipment is installed with a nominal orientation, is less than a first predefined power threshold in the direction of a first reference zone and is less than a second predefined power threshold in the direction of a second reference zone (24), the second predefined power threshold being less than the first predefined power threshold, the second reference zone being a vertical angular cone having the equipment as its apex;
a measuring device designed to measure at least one quantity representative of a current orientation of the equipment;
a processor module designed, if the current orientation of the piece of equipment differs from the nominal orientation and is such that the power radiated in the direction of the second reference zone is likely to exceed the second predefined power threshold, to operate the radiofrequency device in order to limit the power radiated in the direction of the second reference zone and thus ensure that the power radiated in the direction of the second reference zone is less than the second predefined power threshold.

2. The piece of equipment according to claim 1, wherein, to limit the power radiated in the direction of the second reference zone (24), the processor module is designed to limit an electrical power of at least one electrical signal applied between terminals of at least one antenna of the radiofrequency device.

3. The piece of equipment according to claim 1, wherein the radiofrequency device includes a beam steering system comprising an array of a plurality of antennas, the processor module being designed to limit the radiated power, to control phases of electrical signals applied between terminals of the antennas of the beam steering system so as to modify a direction of transmission of an electromagnetic beam generated by the beam steering system.

4. The piece of equipment according to claim 3, wherein the processor module is designed to select, from a predefined table, for all the antennas, phase values associated with the current orientation of the piece of equipment and such that the power radiated in the direction of the second reference zone is less than the second predefined power threshold, and to operate the beam orientation system so that it allocates said phase values to the electrical signals applied to the terminals of the antennas.

5. The piece of equipment according to claim 4, wherein, if the predefined table does not comprise phase values associated with the current orientation and such that the power radiated in the direction of the second reference zone is less than the second predefined power threshold, the processor module selects the phase values associated with the current orientation and with the lowest radiated power value in the direction of the second reference zone, and further limits an electrical power of at least one electrical signal applied between terminals of at least one antenna.

6. The piece of equipment according to claim 4, wherein the current orientation is defined by an azimuth angle and an elevation angle, the predefined table having been obtained from measurements of radiation patterns according to the azimuth angle and the elevation angle, carried out for the different phase values.

7. The piece of equipment according to claim 1, wherein the radiofrequency device comprises antennas, a radiofrequency transmission chain designed to produce electrical signals, and at least one switch designed to implement configurable connections between the antennas and the radiofrequency transmission chain, the processor module being designed, in order to limit the radiated power, to operate the at least one switch in such a way as to reconfigure the configurable connections.

8. The piece of equipment according to claim 1, wherein the at least one quantity representative of the current orientation of the equipment comprises at least one acceleration of the equipment along a predefined axis.

9. The piece of equipment according to claim 8, wherein the processor module is designed to convert the at least one acceleration into at least one angle with respect to at least one reference direction or reference plane.

10. The piece of equipment according to claim 1, wherein the processor module is also designed to produce a notification to a user of the equipment, requesting the user to reposition the equipment in order to reinstall it with the nominal orientation.

11. The piece of equipment according to claim 1, wherein the piece of equipment is an access point.

12. A method for transmitting radiofrequency signals, implemented in the processor module of a piece of equipment according to one of the preceding claims, and comprising the steps of:
acquiring measurements of the at least one quantity representative of the current orientation of the equipment;
if the current orientation of the equipment is such that the power radiated in the direction of the second reference zone is likely to exceed the second predefined power threshold, operating the radiofrequency device to limit the power radiated in the direction of the second reference zone and thus to ensure that the power radiated in the direction of the second reference zone again becomes less than the second predefined power threshold.

13. (canceled)

14. A computer-readable storage medium, on which is stored a computer program comprising instructions which lead the processor module of the equipment according to claim 1, to execute steps of a method for transmitting radiofrequency signals, implemented in the processor module of a piece of equipment according to one of the preceding claims, and comprising the steps of:
acquiring measurements of the at least one quantity representative of the current orientation of the equipment;
if the current orientation of the equipment is such that the power radiated in the direction of the second reference zone is likely to exceed the second predefined power threshold, operating the radiofrequency device to limit the power radiated in the direction of the second reference zone and thus to ensure that the power radiated in the direction of the second reference zone again becomes less than the second predefined power threshold.
